(19) United States
(12) Patent Application Publication
(10) Pub. No.: US 2024/0021941 A1
(43) Pub. Date: Jan. 18, 2024

(54) BATTERY UNIT

(71) Applicant: MURATA MANUFACTURING CO., LTD., Kyoto (JP)

(72) Inventor: Masaaki SUGIYAMA, Kyoto (JP)

(21) Appl. No.: 18/215,367

(22) Filed: Jun. 28, 2023

(30) Foreign Application Priority Data
Jul. 15, 2022 (JP) 2022-114309

(51) Int. Cl. H01M 50/244; H01M 50/213; H01M 50/559

(52) U.S. Cl. CPC H01M 50/244; H01M 50/213; H01M 50/559

(57) ABSTRACT

Provided is a battery unit capable of efficiently moving heat from a cylindrical cell to an end holder. The battery unit of the present disclosure includes a plurality of cylindrical cells and a cell holder. The cell holder includes a first end holder, an intermediate holder, and a second end holder that are arranged in order in a length direction. The intermediate holder includes an intermediate cylindrical hole, a first opening, a first edge, a second opening, and a second edge. The first end holder includes a first cylindrical hole, a third opening, and a third edge. The second end holder includes a second cylindrical hole, a fourth opening, and a fourth edge. The first edge and the third edge constitute an annular first mating surface. The second edge and the fourth edge constitute a second mating surface. At least one of the first mating surface and the second mating surface includes an intersection surface whose sectional shape intersects a planar direction orthogonal to the length direction. An inner diameter of the intermediate cylindrical hole is smaller than an outer diameter of the cylindrical cell.

### CROSS REFERENCE TO RELATED APPLICATIONS

The present application claims priority to Japanese patent application no. JP2022-114309, filed on Jul. 15, 2022, the entire contents of which are incorporated herein by reference.

### BACKGROUND

The present disclosure relates to a battery unit.

A battery pack includes a battery unit and a case in which the battery unit is housed. Such a battery unit includes a plurality of cylindrical cells and a holder that holds the plurality of cylindrical cells. A holder is disclosed as including an intermediate holder that holds a central portion of a cylindrical cell in a length direction, and two end holders that hold end portions of the cylindrical cell in the length direction.

### SUMMARY

In the battery pack, heat generated in the cylindrical cell is transmitted to a wall portion of the case through the cell holder, and is dissipated from the wall portion of the case to the outside. Specifically, heat moves from the end holder of the cell holder to the wall portion of the case. Thus, it is desired that heat can efficiently move from the cylindrical cell to the end holder.

The present disclosure relates to providing a battery unit capable of efficiently moving heat from a cylindrical cell to an end holder according to an embodiment.

A battery unit according to an embodiment of the present disclosure includes: a plurality of cylindrical cells arranged such that electrode terminals face the same direction; and a cell holder that holds the plurality of cylindrical cells. The cell holder includes a first end holder, an intermediate holder, and a second end holder that are arranged in order in a length direction of the cylindrical cell. The intermediate holder includes an intermediate cylindrical hole that penetrates in the length direction of the cylindrical cell and houses an intermediate portion of the cylindrical cell in the length direction, a first opening that opens from the intermediate cylindrical hole toward the first end holder, a first edge that is an edge of the first opening, a second opening that opens from the intermediate cylindrical hole toward the second end holder, and a second edge that is an edge of the second opening. The first end holder includes a first cylindrical hole that penetrates in the length direction and houses one end of the cylindrical cell in the length direction, a third opening that opens from the first cylindrical hole toward the intermediate holder, and a third edge that is an edge of the third opening. The second end holder includes a second cylindrical hole that penetrates in the length direction and houses the other end of the cylindrical cell in the length direction, a fourth opening that opens from the second cylindrical hole toward the intermediate holder, and a fourth edge that is an edge of the fourth opening. The first cylindrical hole, the intermediate cylindrical hole, and the second cylindrical hole are arranged in order in the length direction to form a cell housing portion that houses one cylindrical cell. The same number of the cell housing portions as the plurality of cylindrical cells are provided. The first edge and the third edge are abutted against each other to form an annular first mating surface as viewed in the length direction. The second edge and the fourth edge are abutted against each other to form an annular second mating surface as viewed in the length direction. At least one of a sectional shape of the first mating surface and a sectional shape of the second mating surface includes an intersection surface intersecting a planar direction orthogonal to the length direction. An inner diameter of the intermediate cylindrical hole is smaller than an outer diameter of the cylindrical cell.

According to the present disclosure, in an embodiment, heat efficiently moves from the cylindrical cell to the end holder (the first end holder or the second end holder), and the life of the cylindrical cell can be prolonged.

### BRIEF DESCRIPTION OF THE FIGURES

FIG. 1 is an exploded perspective view of a battery pack 100 according to an embodiment;

FIG. 2 is a perspective view of an intermediate holder;

FIG. 3 is a view of the intermediate holder as viewed from an axial direction;

FIG. 4 is a sectional view of the battery pack taken along a horizontal direction, specifically, a sectional view taken along line IV-IV indicated by arrows in FIG. 3;

FIG. 5 is a perspective view of a first end holder;

FIG. 6 is a view of the first end holder as viewed from a second length direction;

FIG. 7 is a sectional view taken along line VII-VII indicated by arrows in FIG. 4;

FIG. 8 is a sectional view of the battery pack taken along a center line of a cylindrical cell, specifically, a sectional view taken along line VIII-VIII indicated by arrows in FIG. 3;

FIG. 9 is a sectional view of a battery unit of an embodiment taken along the center line of the cylindrical cell;

FIG. 10 is a sectional view of a battery unit of an embodiment taken along the center line of the cylindrical cell;

FIG. 11 is a sectional view of a battery unit of an embodiment taken along the center line of the cylindrical cell;

FIG. 12 is a sectional view of a battery unit of an embodiment taken along the center line of the cylindrical cell;

FIG. 13 is a sectional view of a battery unit of an embodiment taken along the center line of the cylindrical cell, specifically, a sectional view taken along line XIII-XIII in FIG. 14;

FIG. 14 is a view of an intermediate holder of the battery unit of an embodiment as viewed from a first length direction;

FIG. 15 is a sectional view of a battery unit of an embodiment taken along the center line of the cylindrical cell, specifically, a sectional view taken along line XV-XV in FIG. 16;

FIG. 16 is a view of an intermediate holder of the battery unit of an embodiment as viewed from a first length direction; and

FIG. 17 is a sectional view of a battery back of an embodiment taken along the center line of the cylindrical cell.

### DETAILED DESCRIPTION

The present disclosure will be described in further detail including with reference to the drawings according to an embodiment. The present disclosure is not limited thereto and suitable modifications are contemplated including suitable combinations of features including components of the present technology including as described herein according to an embodiment.

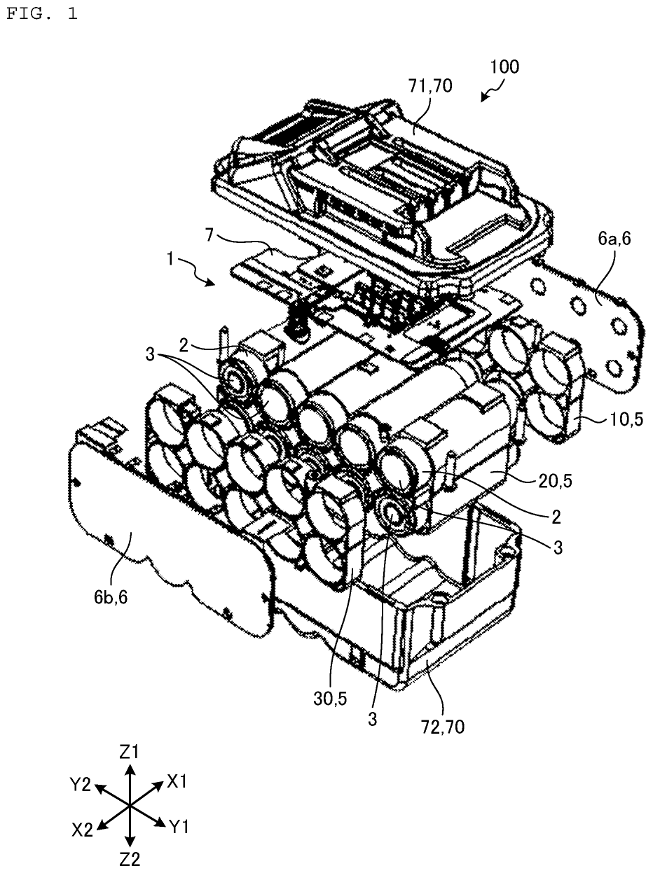

FIG. 1 is an exploded perspective view of a battery pack 100 according to an embodiment. As shown in FIG. 1, the battery pack 100 includes a battery unit 1 and a case 70 in which the battery unit 1 is housed.

The case 70 is a housing made of resin. The case 70 includes a first case 71 and a second case 72 divided in a vertical direction. The first case 71 is disposed above the second case 72 in the vertical direction. Hereinafter, the upper side in the vertical direction is referred to as an upper side Z1. The lower side in the vertical direction is referred to as a lower side Z2. A direction orthogonal to the vertical direction is referred to as a horizontal direction. The first case 71 is an upper wall covering the upper side Z1 of the battery unit 1. The second case 72 is formed in a bottomed cylindrical shape opening on the upper side Z1. The first case 71 and the second case 72 are fastened by bolts (not shown).

The battery unit 1 includes a plurality of cylindrical cells 2, a cell holder 5, a tab 6, and a control board 7. The control board 7 suppresses overdischarge and overcharge of the cylindrical cell 2. The control board 7 is disposed on the upper side Z1 of the cell holder 5, and is fixed to the cell holder 5 by a screw (not shown).

The cylindrical cell 2 is formed in a columnar shape. Hereinafter, a direction in which the cylindrical cell 2 extends is referred to as a length direction. Electrode terminals 3 are provided at both ends in the length direction of the cylindrical cell 2. In the present embodiment, ten cylindrical cells 2 are provided. The ten cylindrical cells 2 are each arranged so as to be parallel to the horizontal direction. In each of the ten cylindrical cells 2, the electrode terminals 3 face the same direction. The ten cylindrical cells 2 are arranged as two rows in the vertical direction and five rows in the horizontal direction. Hereinafter, a direction in which five cylindrical cells are arranged in the horizontal direction is referred to as a width direction. One of the width directions is referred to as a first width direction Y1, and the opposite direction is referred to as a second width direction Y2.

The ten cylindrical cells 2 are arranged such that the respective electrode terminals 3 are located on the same plane. The same plane is a plane extending in the width direction and the vertical direction. Hereinafter, a direction parallel to the same plane is referred to as a planar direction. In the present disclosure, the plurality of electrode terminals 3 need not be arranged on the same plane. That is, the plurality of electrode terminals 3 may be arranged so as to be slightly shifted in the length direction.

The cell holder 5 includes a first end holder 10, an intermediate holder 20, and a second end holder 30 that are arranged in order in the length direction of the cylindrical cell 2. Hereinafter, a direction in which the first end holder 10 is disposed as viewed from the intermediate holder 20 is referred to as a first length direction X1. A direction in which the second end holder 30 is disposed as viewed from the intermediate holder 20 is referred to as a second length direction X2.

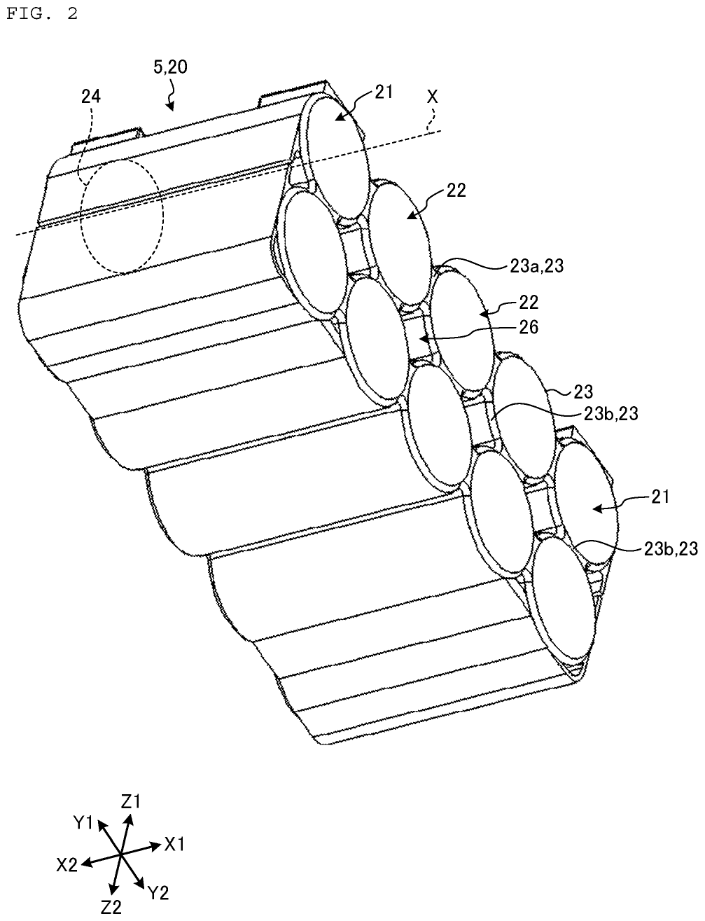

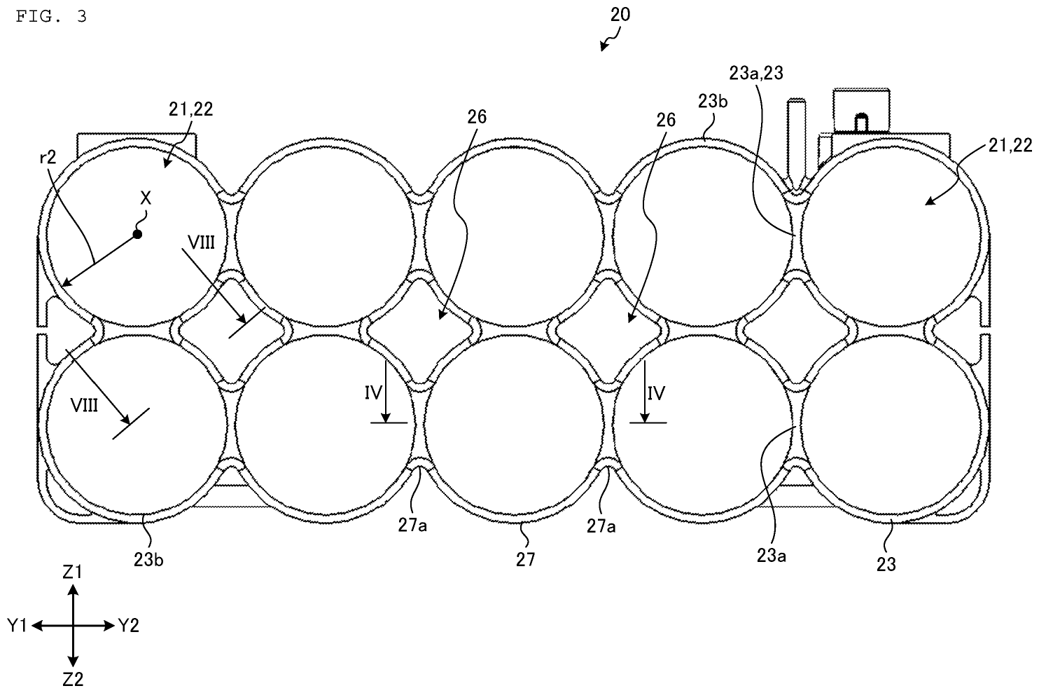

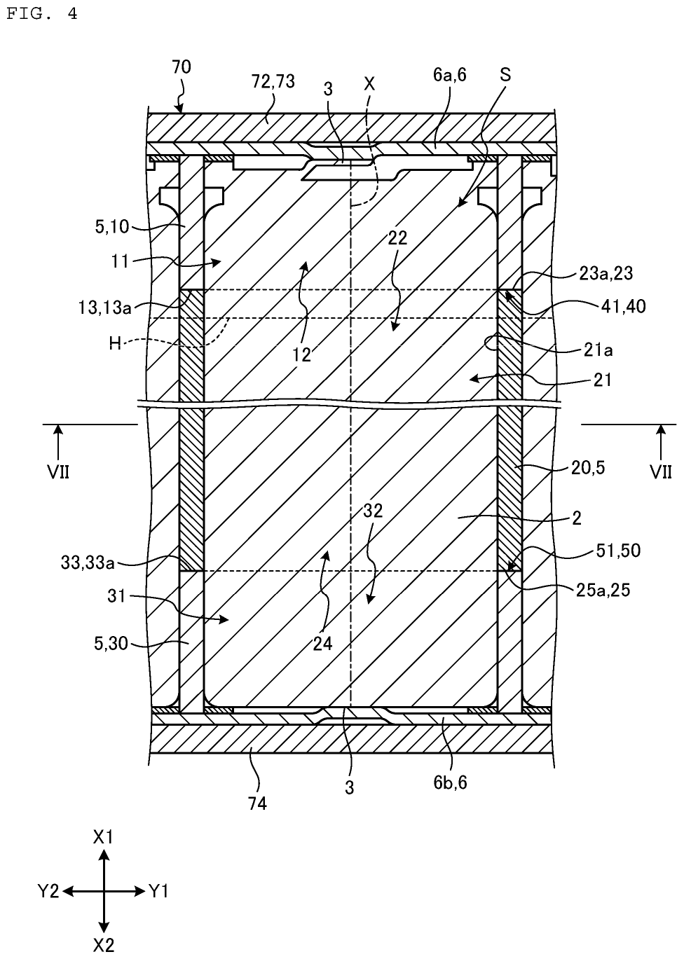

FIG. 2 is a perspective view of the intermediate holder. FIG. 3 is a view of the intermediate holder as viewed from an axial direction. FIG. 4 is a sectional view of the battery pack taken along the horizontal direction, specifically, a sectional view taken along line IV-IV indicated by arrows in FIG. 3. As shown in FIGS. 2 to 4, the intermediate holder 20 includes an intermediate cylindrical hole 21, a first opening 22, a first edge 23, a second opening 24 (not shown in FIG. 3, see FIG. 2), and a second edge 25 (not shown in FIGS. 2 and 3, see FIG. 4).

The intermediate cylindrical hole 21 penetrates the intermediate holder 20 in the length direction. A section of the intermediate cylindrical hole 21 is formed in a circular shape around a center line X (see FIGS. 2 and 3) of the cylindrical cell 2. The number of the intermediate cylindrical holes 21 is ten, which is the same as the number of the cylindrical cells 2, and the intermediate cylindrical holes are arranged as two rows in the vertical direction and five rows in the horizontal direction. An intermediate portion of the cylindrical cell 2 is housed in the intermediate cylindrical hole 21 (see FIG. 4).

The first opening 22 opens in the first length direction X1 from the intermediate cylindrical hole 21. Thus, the first opening 22 opens toward the first end holder 10. The first edge 23 is an edge of the first opening 22. The first edge 23 is formed in a circular shape (annular shape) around the center line X of the cylindrical cell 2. As shown in FIG. 3, a portion of the first edge 23 in a circumferential direction constitutes a merging portion 23a that merges with another first edge 23 adjacent in the width direction or the vertical direction. Thus, the first edge 23 includes the merging portion 23a and an independent portion 23b which is a portion other than the merging portion 23a.

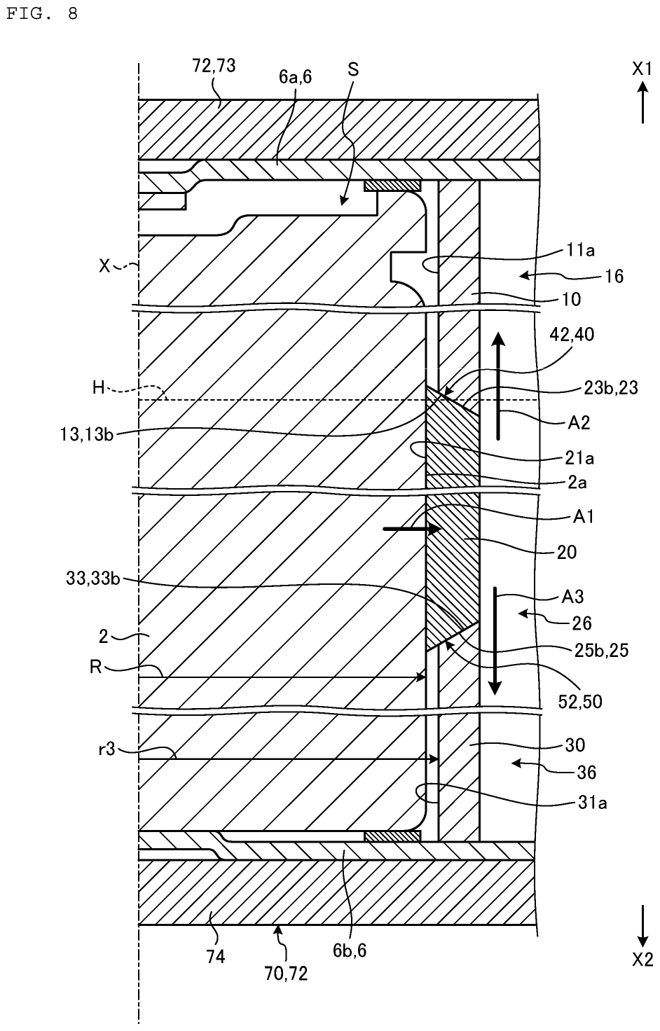

As shown in FIG. 4, the second opening 24 is an opening that opens from the intermediate cylindrical hole 21 in the second length direction X2. That is, the second opening 24 opens toward the second end holder 30. The second edge 25 is an edge of the second opening 24. The second edge 25 is formed in a circular shape (annular shape) around the center line X. Similarly to the first edge 23, the second edge 25 includes a merging portion 25a (see FIG. 4) and an independent portion 25b (see FIG. 8).

In addition, as shown in FIGS. 2 and 3, the intermediate holder 20 is provided with a plurality of lightening holes 26. As shown in FIG. 3, a bottom surface 27 of the intermediate holder 20 is provided with a groove 27a recessed upward. The groove 27a extends in the length direction.

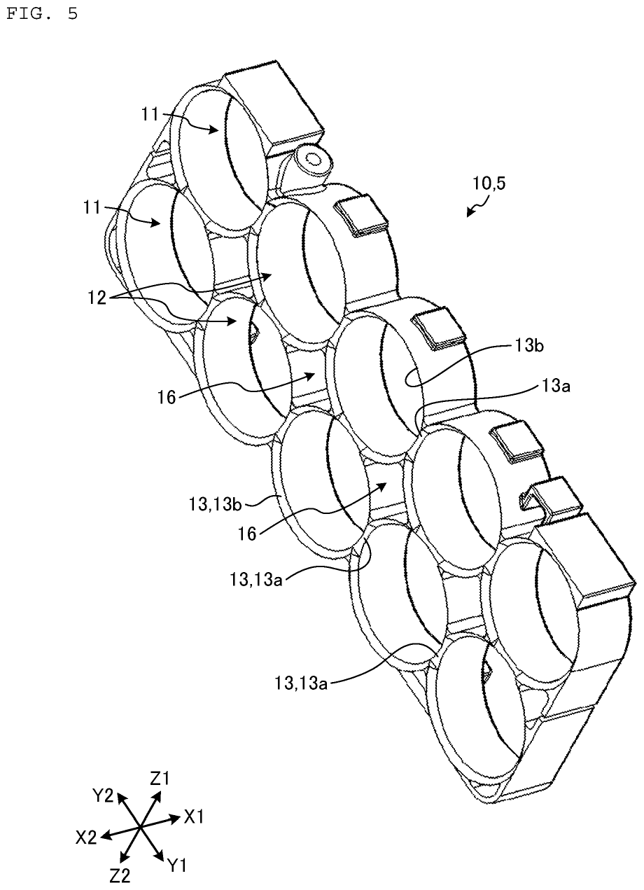

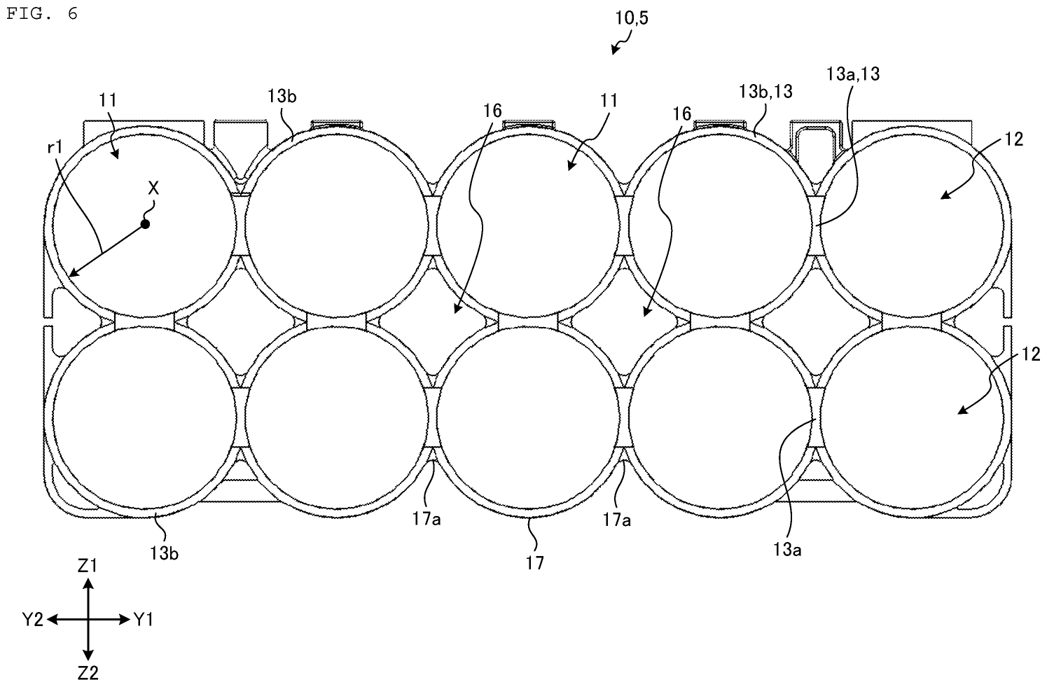

FIG. 5 is a perspective view of the first end holder. FIG. 6 is a view of the first end holder as viewed from the second length direction. As shown in FIGS. 5 and 6, the first end holder 10 includes a first cylindrical hole 11, a third opening 12, and a third edge 13.

The first cylindrical hole 11 penetrates the first end holder 10 in the length direction. Similarly to the intermediate cylindrical hole 21, ten first cylindrical holes 11 are provided. The ten first cylindrical holes 11 are arranged as two rows in the vertical direction and five rows in the horizontal direction.

The third opening 12 opens in the second length direction X2 from the first cylindrical hole 11. That is, the third opening 12 opens toward the intermediate holder 20. The third edge 13 is an edge of the third opening 12. The third edge 13 is formed in a circular shape (annular shape). Similarly to the first edge 23, the third edge 13 includes a merging portion 13a and an independent portion 13b. In addition, the first end holder 10 is provided with a plurality of lightening holes 16. As shown in FIG. 6, a bottom surface 17 of the first end holder 10 is provided with a groove 17a recessed upward. The groove 17a extends in the length direction.

As shown in FIG. 4, an end of the cylindrical cell 2 in the first length direction X1 is housed in the intermediate cylindrical hole 21. The third edge 13 is abutted against the first edge 23 of the intermediate holder 20. Hereinafter, an annular surface portion where the first edge 23 and the third edge 13 overlap (are abutted) is referred to as a first mating surface 40.

The second end holder 30 and the first end holder 10 are formed plane symmetrically with respect to the intermediate holder 20. Thus, each configuration of the second end holder 30 will be briefly described. As shown in FIG. 4, the second end holder 30 includes a second cylindrical hole 31, a fourth opening 32, and a fourth edge 33. The second cylindrical hole 31 penetrates the second end holder 30 in the length direction. Similarly to the intermediate cylindrical hole 21, ten second cylindrical holes 31 are provided. The ten second cylindrical holes 31 are arranged as two rows in the vertical direction and five rows in the horizontal direction. An end of the cylindrical cell 2 in the second length direction X2 is housed in the second cylindrical hole 31.

The fourth opening 32 opens toward the intermediate holder 20. The fourth edge 33 is an edge of the fourth opening 32. The fourth edge 33 is formed in a circular shape (annular shape). Similarly to the first edge 23, the fourth edge 33 includes a merging portion 33a and an independent portion 33b (see FIGS. 4 and 8). In the fourth edge 33, the second edge 25 is abutted from the second length direction X2. Hereinafter, an annular surface portion where the second edge 25 and the fourth edge 33 overlap (are abutted) is referred to as a second mating surface 50. Although not particularly illustrated, the bottom surface of the second end holder 30 is provided with a groove recessed upward, similarly to the bottom surface 17 of the first end holder 10 and the bottom surface 27 of the intermediate holder 20. Similarly to the first end holder 10, the second end holder 30 is provided with a plurality of lightening holes 36 (see FIG. 8).

From the above, in the cell holder 5, as shown in FIG. 4, the first cylindrical hole 11, the intermediate cylindrical hole 21, and the second cylindrical hole 31 are arranged in order from the first length direction X1 to form the cell housing portion S in which one cylindrical cell 2 is housed. The same number of first cylindrical holes 11, intermediate cylindrical holes 21, and second cylindrical holes 31 as the plurality of cylindrical cells 2 are provided. Thus, the same number of the cell housing portions S as the plurality of cylindrical cells 2 are provided.

As shown in FIG. 1, the tab 6 is a metal plate extending in the planar direction. The tab 6 includes a first tab 6a and a second tab 6b. The first tab 6a is disposed in the first length direction X1 with respect to the first end holder 10. The second tab 6b is disposed in the second length direction X2 with respect to the second end holder 30.

As shown in FIG. 4, the first tab 6a is joined to the electrode terminal 3 in the first length direction X1 of the cylindrical cell 2 with the first cylindrical hole 11 of the first end holder 10 interposed therebetween. The second tab 6b is joined to the electrode terminal 3 in the second length direction X2 of the cylindrical cell 2 with the second cylindrical hole 31 of the second end holder 30 interposed therebetween.

The first tab 6a is abutted against the first wall portion 73 of the second case 72 disposed in the first length direction X1. Furthermore, the first tab 6a is abutted against an end of the first end holder 10 in the first length direction X1. Thus, heat moved from the cylindrical cell 2 to the intermediate holder 20 moves in the order of the first end holder 10, the first tab 6a, and the first wall portion 73, and is released from the first wall portion 73 to the outside of the case 70.

The second tab 6b is abutted against a second wall portion 74 of the second case 72 disposed in the second length direction X2. Furthermore, the second tab 6b is abutted against an end of the second end holder 30 in the second length direction X2. Thus, heat moved from the cylindrical cell 2 to the intermediate holder 20 moves in the order of the second end holder 30, the second tab 6b, and the second wall portion 74, and is released from the second wall portion 74 to the outside of the case 70.

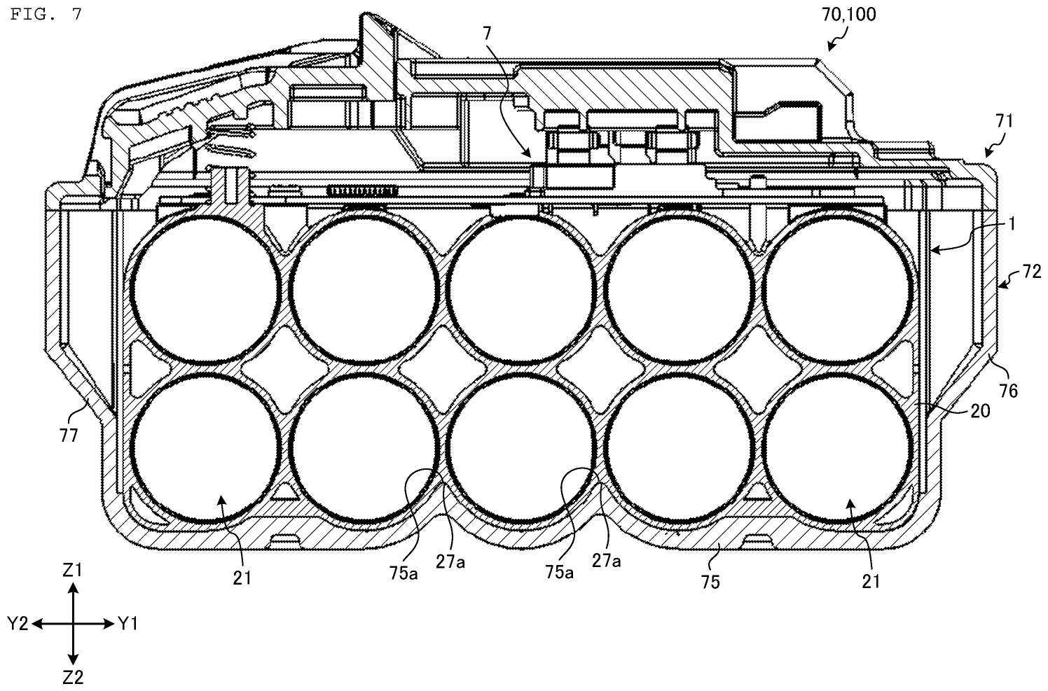

FIG. 7 is a sectional view taken along line VII-VII indicated by arrows in FIG. 4. As shown in FIG. 7, the second case 72 includes a bottom wall portion 75. The bottom wall portion 75 is provided with a protrusion 75a protruding upward. The protrusion 75a extends in the length direction. A sectional shape of the protrusion 75a cut in the planar direction is the same as the groove 17a (see FIG. 6) of the first end holder 10, the groove 27a of the intermediate holder 20, and a groove (not illustrated) of the second end holder 30. The protrusion 75a enters the groove 17a (see FIG. 6) of the first end holder 10, the groove 27a of the intermediate holder 20, and the groove (not illustrated) of the second end holder 30.

The second case 72 includes a third wall portion 76 disposed in the first width direction Y1 and a fourth wall portion 77 disposed in the second width direction Y2. The third wall portion 76 and the fourth wall portion 77 are abutted against a side surface in the width direction of each of the first end holder 10, the intermediate holder 20, and the second end holder 30. Thus, in the case 70, the battery unit 1 is positioned so as not to rattle in the width direction.

FIG. 8 is a sectional view of the battery pack taken along the center line of the cylindrical cell, specifically, a sectional view taken along line VIII-VIII indicated by arrows in FIG. 3. Next, details of the cell holder 5 will be described. The intermediate holder 20 is formed of an elastic body that is elastically deformable. Examples of the elastically deformable material include rubber. Specific examples of the rubber forming the intermediate holder 20 include natural rubber, EPDM (ethylene-propylene rubber), CR (chloroprene rubber), IIR (butyl rubber), polyurethane rubber, and silicone rubber.

On the other hand, the first end holder 10 and the second end holder 30 are made of resin. Specific examples of the resins forming the first end holder 10 and the second end holder 30 include ABS (styrene-acrylonitrile-butadiene), EP (epoxy resin), ETFE (tetrafluoroethylene-ethylene copolymer), FEP (tetrafluoroethylene-hexafluoropropylene copolymer), PA (polyamide (6 nylon)), PBTP (polybutylene terephthalate), PC (polycarbonate), PE (Polyethylene (low density) and polyethylene (high density)), PEEK (polyether ether ketone), PESF (polyether sulfone), PETP (polyethylene terephthalate), PF (phenol resin), PFA (tetrafluoroethylene-perfluorovinyl ether copolymer), PI (polyimide), PMMA (polymethyl methacrylate (acrylic)), POM (polyacetal (duracone)), PP (polypropylene), PPE (polyphenylene sulfide), PS (polystyrene), PSF (polysulfone), PTFE (tetrafluoroethylene resin), PVC (polyvinyl chloride (hard) and polyvinyl chloride (soft)), and SI (silicone resin).

The rubber has a Young's modulus of less than 0.7 GPa. On the other hand, the resin has a Young's modulus of 1 GPa or more and 2.5 GPa or less. Thus, when a load acts, the resin (the first end holder 10 and the second end holder 30) is hardly deformed and has high rigidity.

An inner diameter r1 (see FIG. 6) of the first cylindrical hole 11 and an inner diameter r3 (see FIG. 8) of the second cylindrical hole 31 are normal diameters. This normal diameter is slightly larger than an outer diameter R (see FIG. 8) of the cylindrical cell 2 so as to be able to absorb manufacturing errors of the cylindrical cell 2. Thus, as shown in FIG. 8, a minute gap is generated between an inner peripheral surface 11a of the first cylindrical hole 11 and an outer peripheral surface 2a of the cylindrical cell 2. Similarly, a minute gap is generated between an inner peripheral surface 31a of the second cylindrical hole 31 and the outer peripheral surface 2a of the cylindrical cell 2. For this reason, heat of the cylindrical cell 2 hardly moves to the first end holder 10 and the second end holder 30. The gap between the cylindrical cell 2 and the first end holder 10 and the gap between the cylindrical cell 2 and the second end holder 30 are not shown in FIG. 4 because they are minute.

On the other hand, an inner diameter r2 (see FIG. 3) of the intermediate cylindrical hole 21 is smaller than the outer diameter R of the cylindrical cell 2. Thus, an inner peripheral surface 21a of the intermediate cylindrical hole 21 is in close contact with the outer peripheral surface 2a of the cylindrical cell 2 without any gap. Thus, heat of the cylindrical cell 2 easily moves to the intermediate holder 20 (see arrow A1 in FIG. 8). The intermediate holder 20 is made of rubber and has high specific heat. This also causes a large amount of heat to move from the cylindrical cell 2 to the intermediate holder 20. Since the inner peripheral surface 21a is in close contact with the outer peripheral surface 2a, the cylindrical cell 2 does not slide on the inner peripheral surface 21a of the intermediate cylindrical hole 21. As a result, frictional heat is less likely to be generated between the cylindrical cell 2 and the inner peripheral surface 21a of the intermediate cylindrical hole 21. In addition, since the intermediate holder 20 is formed of an elastic body, manufacturing errors of the cylindrical cell 2 can be absorbed.

The first mating surface 40 includes the first edge 23 of the intermediate holder 20 and the third edge 13 of the first end holder 10. As shown in FIG. 4, a sectional shape obtained by cutting the merging portion 23a of the first edge 23 and the merging portion 13a of the third edge 13 along the center line X of the cylindrical cell 2 is parallel to the planar direction (see a virtual plane H). Thus, the merging portion 23a of the first edge 23 and the merging portion 13a of the third edge 13 constitute a flat surface 41 parallel to the planar direction.

On the other hand, as shown in FIG. 8, a sectional shape obtained by cutting the independent portion 23b of the first edge 23 and the independent portion 13b of the third edge 13 along the center line X of the cylindrical cell 2 intersects the planar direction (see the virtual plane H). Thus, the independent portion 23b of the first edge 23 and the independent portion 13b of the third edge 13 constitute an intersection surface 42 intersecting the planar direction. Specifically, a sectional shape of the intersection surface 42 is a linear slope. More specifically, the sectional shape of the slope (intersection surface 42) is inclined so as to be located in the second length direction X2 as being away from the cylindrical cell 2.

Thus, the first mating surface 40 includes the intersection surface 42. Thus, a contact area between the first edge 23 and the third edge 13 increases as compared with a case where the first mating surface 40 is formed only of the flat surface 41. Thus, heat easily moves from the intermediate holder 20 to the first end holder 10 (see arrow A2 in FIG. 8). In the present embodiment, both the independent portion 23b and the independent portion 13b are slopes (intersection surfaces 42), and the slope (intersection surface 42) extends in the circumferential direction. Thus, the contact area between the first edge 23 and the third edge 13 increases as compared with a case where the slope (intersection surface 42) is provided only in a part of the independent portions 23b and 13b. Also for this reason, heat easily moves from the intermediate holder 20 to the first end holder 10. From the above, a large amount of heat moves from the intermediate holder 20 to the first end holder 10.

The second mating surface 50 includes the second edge 25 of the intermediate holder and the fourth edge 33 of the second end holder. As shown in FIG. 4, a sectional shape obtained by cutting the merging portion 25a of the second edge 25 and the merging portion 33a of the fourth edge 33 along the center line X of the cylindrical cell 2 is parallel to the planar direction. Thus, the merging portion 25a of the second edge 25 and the merging portion 33a of the fourth edge 33 constitute a flat surface 51 parallel to the planar direction.

On the other hand, as shown in FIG. 8, a sectional shape obtained by cutting the independent portion 25b of the second edge 25 and the independent portion 33b of the fourth edge 33 along the center line X of the cylindrical cell 2 intersects the planar direction. Thus, the independent portion 25b of the second edge 25 and the independent portion 33b of the fourth edge 33 constitute an intersection surface 52 intersecting the planar direction. Specifically, a sectional shape of the intersection surface 52 is a linear slope. More specifically, the sectional shape of the slope (intersection surface 52) is inclined so as to be located in the first length direction X1 as being away from the cylindrical cell 2. Both the independent portions 25b and 33b are slopes (intersection surfaces 52). From the above, a contact area between the second edge 25 and the fourth edge 33 increases, and a large amount of heat moves from the intermediate holder 20 to the second end holder 30 (see arrow A3 in FIG. 8).

As described above, according to the battery unit 1, heat efficiently moves from the cylindrical cell 2 to the first end holder 10 and the second end holder 30. Thus, an increase in temperature of the cylindrical cell 2 is avoided, and the life of the cylindrical cell 2 can be prolonged. In the cell holder 5, the first end holder 10 and the second end holder 30 have high rigidity and high supporting strength for supporting the cylindrical cell 2. Thus, when an external force is input to the battery pack 100, the cylindrical cell 2 is hardly damaged.

Although an embodiment has been described above, the present disclosure is not limited thereto. For example, the intersection surfaces 42 and 52 are provided on both the first mating surface 40 and the second mating surface 50; however, in the present disclosure, the intersection surfaces 42 and 52 may be provided on at least one of the first mating surface 40 and the second mating surface 50 according to an embodiment.

In the present embodiment, the intersection surfaces 42 and 52 are provided at the independent portions 13b, 23b, 25b, and 33b; however, in the present disclosure, the intersection surfaces 42 and 52 may be provided at the merging portions 13a, 23a, 25a, and 33a according to an embodiment. The intersection surfaces 42 and 52 may be provided on the entire peripheries of the first edge 23, the second edge 25, the third edge 13, and the fourth edge 33. In addition, the intersection surfaces 42 and 52 may be intermittently provided in the circumferential direction. That is, the intersection surfaces 42 and 52 and the flat surfaces 41 and 51 may be alternately provided with respect to the first edge 23, the second edge 25, the third edge 13, and the fourth edge 33.

The sectional shapes of the intersection surfaces 42 and 52 are not limited to the examples described above. For example, the slope (intersection surface 52) may be applied to the first mating surface 40, and the slope (intersection surface 42) may be applied to the second mating surface 50 according to an embodiment. The sectional shapes of the intersection surfaces 42 and 52 may be shapes other than the slopes. Hereinafter, the intersection surfaces 42 and 52 other than the slopes will be described. In the following, the first mating surface 40 will be described as a representative example; however, the slope may be applied to the second mating surface 50 according to an embodiment.

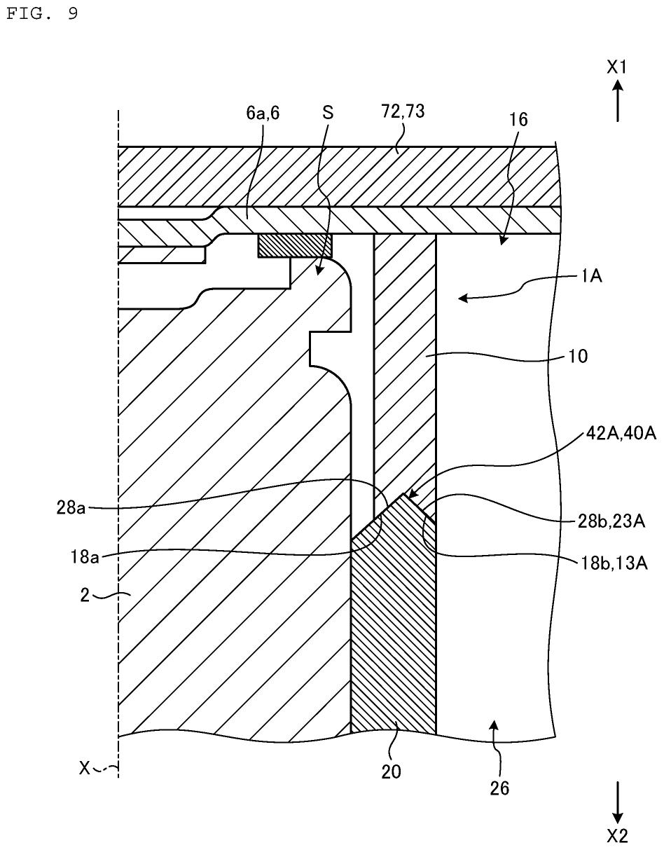

FIG. 9 is a sectional view of a battery unit of an embodiment taken along the center line of the cylindrical cell. In a battery unit 1A, a first mating surface 40A includes a first edge 23A of the intermediate holder 20 and a third edge 13A of the first end holder 10. The first edge 23A includes a first slope 28a and a second slope 28b. The first slope 28a is inclined so as to be positioned in the first length direction X1 as being away radially outward from the cylindrical cell 2. The second slope 28b is inclined so as to be positioned in the second direction as being away radially outward from the cylindrical cell 2 from a radially outer end of the first slope 28a. Thus, a sectional shape of the first edge 23A is a V shape, and is sharpened toward the first length direction X1.

The third edge 13A includes a third slope 18a and a fourth slope 18b. The third slope 18a is inclined so as to be positioned in the first length direction X1 as being away radially outward from the cylindrical cell 2. The fourth slope 18b is inclined so as to be positioned in the second length direction X2 as being away radially outward from the cylindrical cell 2 from a radially outer end of the third slope 18a. Thus, a sectional shape of the third edge 13A is a V shape, and a width between the third slope 18a and the fourth slope 18b becomes narrower toward the first length direction X1. The first slope 28a and the third slope 18a are abutted against each other, and the second slope 28b and the fourth slope 18b are abutted against each other.

As described above, the first mating surface 40A includes the intersection surface 42A having a V-shaped sectional shape, and the contact area increases. Thus, heat efficiently moves from the intermediate holder 20 to the first end holder 10 according to an embodiment.

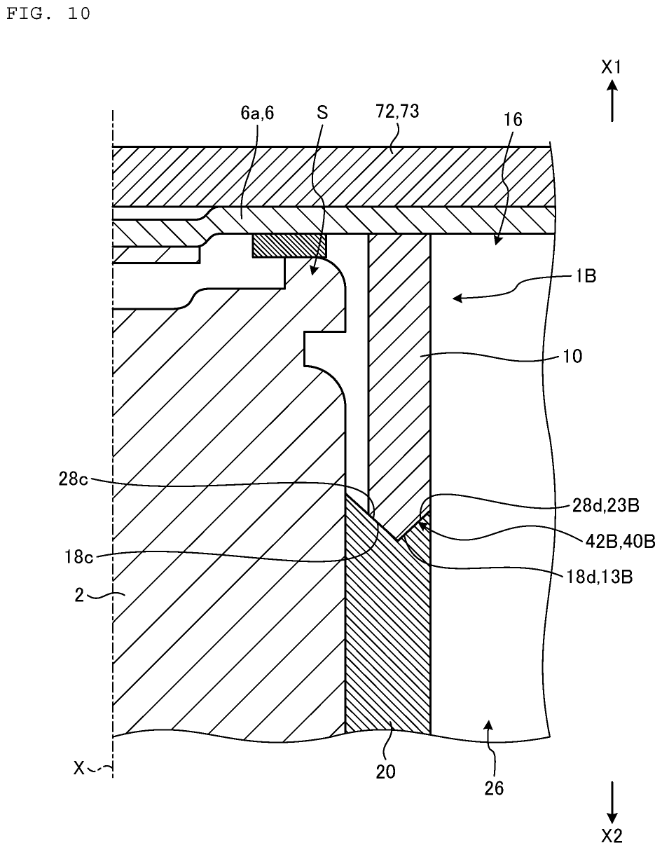

FIG. 10 is a sectional view of a battery unit of an embodiment taken along the center line of the cylindrical cell. In a battery unit 1B, a first mating surface 40B includes a first edge 23B of the intermediate holder 20 and a third edge 13B of the first end holder 10. The first edge 23B includes a first slope 28c and a second slope 28d. The first slope 28c is inclined so as to be positioned in the second length direction X2 as being away radially outward from the cylindrical cell 2. The second slope 28d is inclined so as to be positioned in the first length direction X1 as being away radially outward from the cylindrical cell 2 from a radially outer end of the first slope 28c. Thus, a sectional shape of the first edge 23B is a V shape, and a width between the first slope 28c and the second slope 28d becomes narrower toward the second length direction X2.

The third edge 13B includes a third slope 18c and the fourth slope 18b. The third slope 18c is inclined so as to be positioned in the second length direction X2 as being away radially outward from the cylindrical cell 2. The fourth slope 18b is inclined so as to be positioned in the first length direction X1 as being away radially outward from the cylindrical cell 2 from a radially outer end of the third slope 18c. Thus, a sectional shape of the third edge 13B is a V shape, and is sharpened toward the second length direction X2. The first slope 28c and the third slope 18c are abutted against each other, and the second slope 28d and the fourth slope 18d are abutted against each other.

As described above, the first mating surface 40B includes the intersection surface 42B having a V-shaped sectional shape, and the contact area increases. Thus, heat efficiently moves from the intermediate holder 20 to the first end holder 10 according to an embodiment.

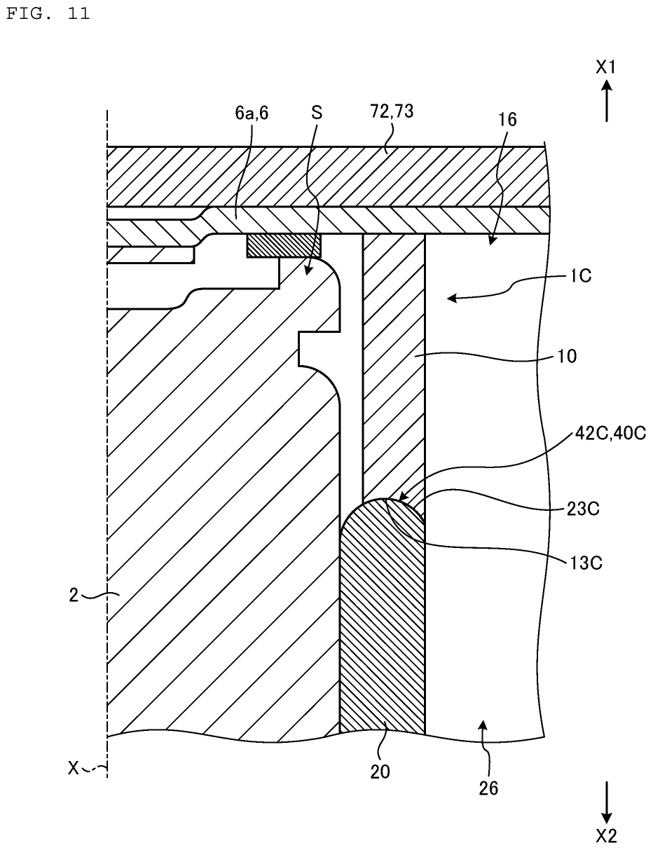

FIG. 11 is a sectional view of a battery unit of an embodiment taken along the center line of the cylindrical cell. In a battery unit 1C, a first mating surface 40C includes a first edge 23C of the intermediate holder 20 and a third edge 13C of the first end holder 10. A sectional shape of the first edge 23C is an arc surface, and the central portion protrudes in the first length direction X1. A sectional shape of the third edge 13C is an arc surface, and the central portion is recessed in the first length direction X1. The third edge 13C is abutted against the first edge 23C. A sectional shape of an intersection surface 42C is an arc shape. As described above, the first mating surface 40C includes the intersection surface 42C having an arc-shaped sectional shape, and the contact area increases. Thus, heat efficiently moves from the intermediate holder 20 to the first end holder 10 according to an embodiment.

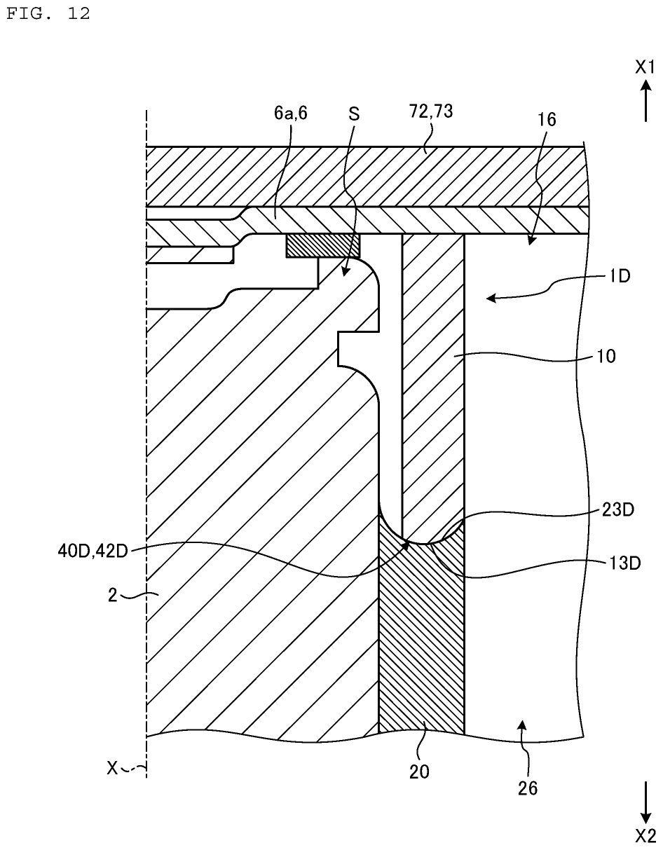

FIG. 12 is a sectional view of a battery unit of an embodiment taken along the center line of the cylindrical cell. In a battery unit 1D, a first mating surface 40D includes a first edge 23D of the intermediate holder 20 and a third edge 13D of the first end holder 10. A sectional shape of the first edge 23D is an arc surface, and the central portion is recessed in the second length direction X2. A sectional shape of the third edge 13D is an arc surface, and the central portion protrudes in the second length direction X2. The third edge 13D is abutted against the first edge 23D. A sectional shape of an intersection surface 42D is an arc shape. As described above, the first mating surface 40D includes the intersection surface 42D having an arc-shaped sectional shape, and the contact area increases. Thus, heat efficiently moves from the intermediate holder 20 to the first end holder 10 according to an embodiment.

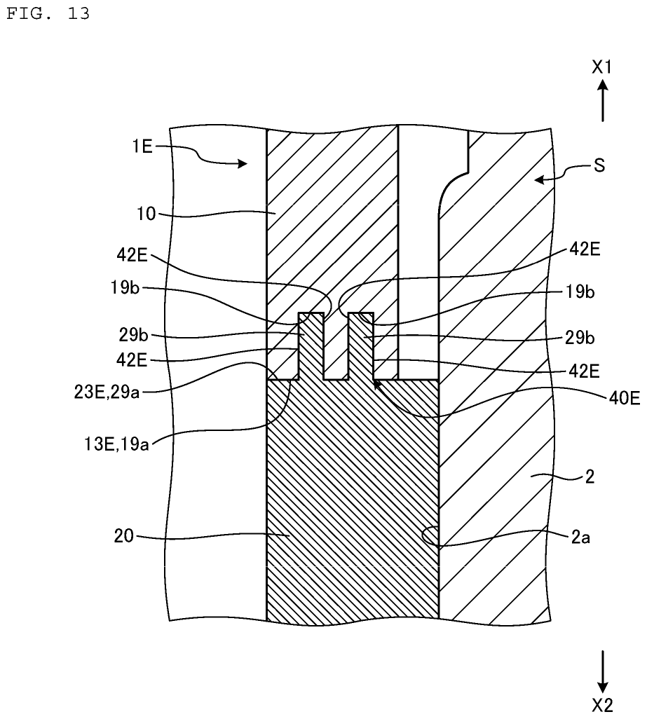

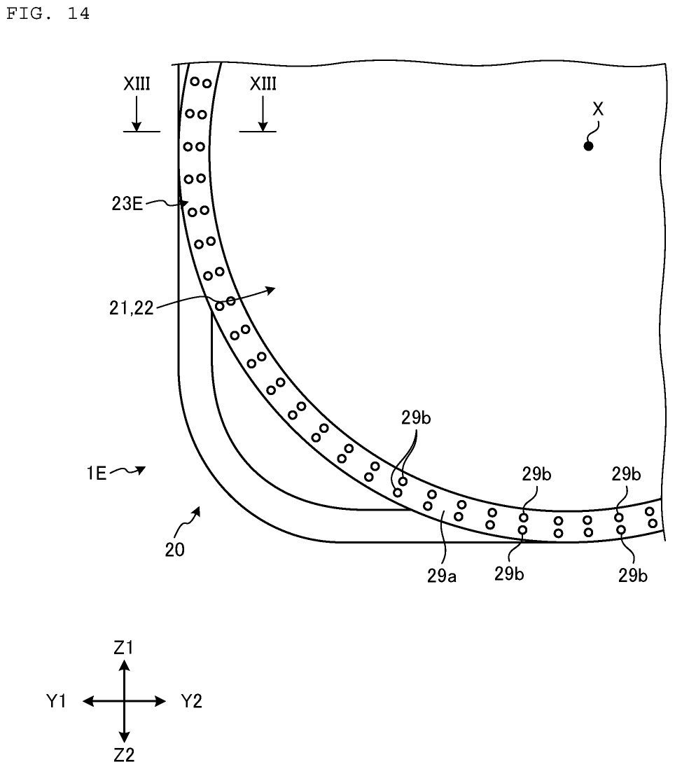

FIG. 13 is a sectional view of a battery unit of an embodiment taken along the center line of the cylindrical cell, specifically, a sectional view taken along line XIII-XIII in FIG. 14. FIG. 14 is a view of the intermediate holder of the battery unit of an embodiment as viewed from the first length direction. As shown in FIG. 13, in a battery unit 1E, a first mating surface 40E includes a first edge 23E of the intermediate holder 20 and a third edge 13E of the first end holder 10.

As shown in FIGS. 13 and 14, the first edge 23E includes a flat surface 29a flat in the planar direction and a column portion 29b protruding from the flat surface 29a in the first length direction. The column portion 29 has a circular shape when viewed from the length direction. That is, the column portion 29 is formed in a columnar shape. Every two column portions 29b are arranged radially from the center line X of the cylindrical cell 2. In addition, a plural pairs of the column portions 29b aligned radially are arranged in the circumferential direction around the center line X of the cylindrical cell 2. Thus, as shown in FIG. 13, the first edge 23E includes the flat surface 29a and the two column portions 29 protruding from the flat surface 29a. Thus, the sectional shape of the first edge 23E is a rectangular wave shape.

The third edge 13E includes a flat surface 19a flat in the planar direction and a hole 19b recessed from the flat surface 19a in the first length direction. The hole 19b is a hole into which the column portion 29b is inserted. Thus, the hole 19b corresponds to the column portion 29b, and every two holes 19b are arranged radially from the center line X of the cylindrical cell 2. In addition, a plural pairs of the holes 19b aligned radially are arranged radially around the center line X of the cylindrical cell 2. Thus, as shown in FIG. 13, the third edge 13E includes the flat surface 19a and the two holes 19b recessed from the flat surface 19a. Thus, the sectional shape of the third edge 13E is a rectangular wave shape.

According to an embodiment, a sectional shape of the first mating surface 40E is a rectangular wave shape. Thus, the sectional shape of the first mating surface 40E includes four linear intersection surfaces 42E extending in the length direction, and the contact area increases. Thus, heat efficiently moves from the intermediate holder 20 to the first end holder 10 according to an embodiment. The rectangular wave shape including the four intersection surfaces 42E is intermittently provided in the circumferential direction according to an embodiment.

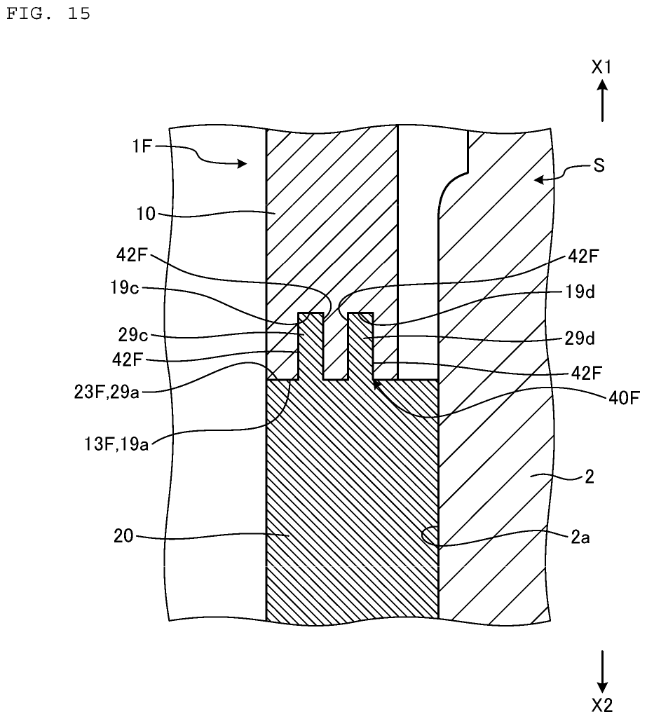

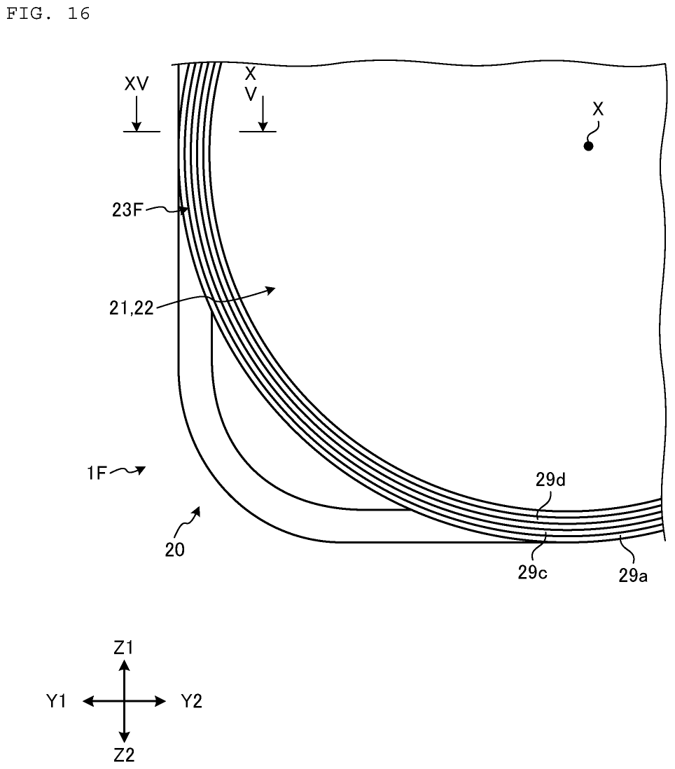

FIG. 15 is a sectional view of a battery unit of an embodiment taken along the center line of the cylindrical cell, specifically, a sectional view taken along line XV-XV in FIG. 16. FIG. 16 is a view of the intermediate holder of the battery unit of an embodiment as viewed from the first length direction. As shown in FIG. 15, in a battery unit 1F, a first mating surface 40F includes a first edge 23F of the intermediate holder 20 and a third edge 13F of the first end holder 10.

As shown in FIGS. 15 and 16, the first edge 23F includes the flat surface 29a flat in the planar direction, and a first protrusion 29c and a second protrusion 29d provided on the flat surface 29a. The second protrusion 29d is disposed on an inner peripheral side with respect to the first protrusion 29c. The first protrusion 29c and the second protrusion 29d protrude from the flat surface 29a in the first length direction X1. Each of the first protrusion 29c and the second protrusion 29d has a rectangular sectional shape. The first protrusion 29c and the second protrusion 29d are continuous in the circumferential direction around the center line X of the cylindrical cell 2 and are formed in an annular shape (circular shape). Thus, as shown in FIG. 15, a sectional shape of the first edge 23F is a rectangular wave shape.

The third edge 13F includes the flat surface 19a flat in the planar direction and a first groove 19c and a second groove 19d recessed from the flat surface 19a in the first length direction. The first groove 19c is a groove into which the first protrusion 29c is inserted. The second groove 19d is a groove into which the second protrusion 29d is inserted. Thus, the second groove 19d is disposed on the inner peripheral side with respect to the first groove 19c. The first groove 19c and the second groove 19d are recessed from the flat surface 19a in the first length direction. Sectional shapes of the first groove 19c and the second groove 19d are rectangular. Although not particularly shown, the first groove 19c and the second groove 19d are continuous in the circumferential direction around the center line X of the cylindrical cell 2 and are annular (circular). Thus, as shown in FIG. 15, a sectional shape of the third edge 13F is a rectangular wave shape in which the first groove 19c and the second groove 19d are recessed from the flat surface 19a.

According to an embodiment, a sectional shape of the first mating surface 40F is a rectangular wave shape. Thus, the sectional shape of the first mating surface 40F includes four linear intersection surfaces 42F extending in the length direction, and the contact area increases. Thus, similarly to the embodiment, heat efficiently moves from the intermediate holder 20 to the first end holder 10. According to an embodiment, the rectangular wave shape including the four intersection surfaces 42F is intermittently provided in the circumferential direction.

One or more modifications of the intersection surface have been described above according to an embodiment. Next, an example in which the sectional shape of the first mating surface and the sectional shape of the second mating surface are different will be described according to an embodiment.

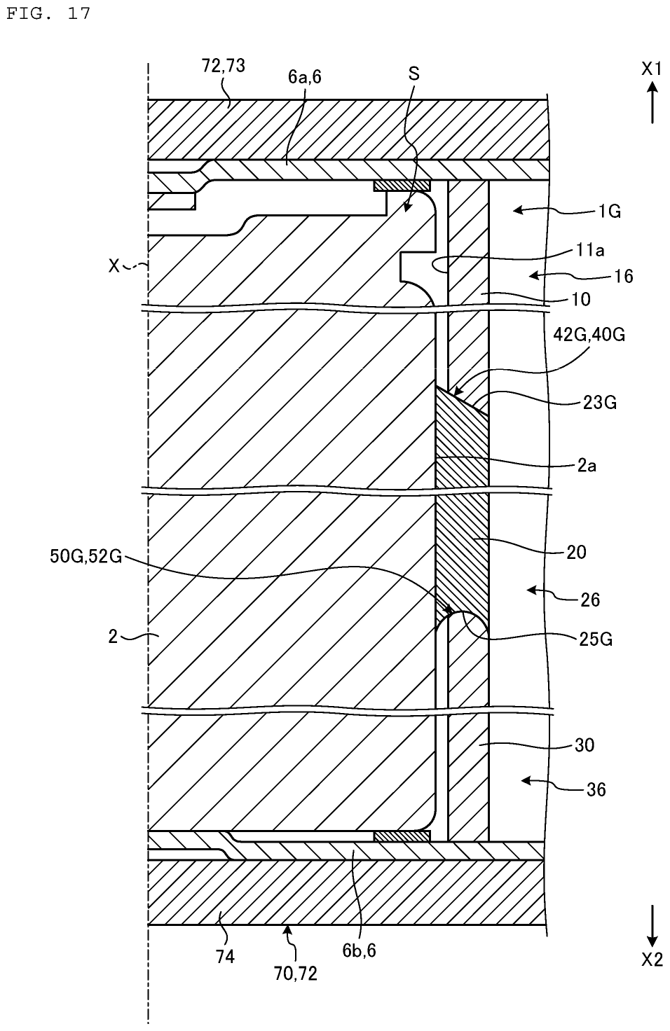

FIG. 17 is a sectional view of a battery back of an embodiment taken along the center line of the cylindrical cell. The first mating surface 40 as described above is applied to a first mating surface 40G of a battery unit 1G of an embodiment. That is, the first mating surface 40G includes a slope (intersection surface 42G) inclined so as to be located in the second length direction X2 as being away from the cylindrical cell 2. On the other hand, the first mating surface 40C as described above is applied to the second mating surface 50G of the battery unit 1G. That is, the second mating surface 50G includes an arc surface-shaped intersection surface 52G in which a central portion in the radial direction protrudes in the first length direction.

From the above, the sectional shape of the first edge 23G of the intermediate holder 20 is a slope inclined so as to be located in the second length direction X2. On the other hand, a sectional shape of the second edge 25G is an arc surface in which the central portion in the radial direction is recessed in the first length direction. Thus, since the shapes of the first edge 23G and the second edge 25G are different, the direction of the intermediate holder 20 can be visually recognized. As a result, the fact that the cylindrical cell 2 is inserted into the intermediate holder 20 with its direction being wrong is avoided, and productivity is improved.

One or more embodiments including modifications have been described herein. The intermediate holder of the present disclosure is not limited thereto including made only of rubber, and for example, a phase change material such as paraffin may be contained in the rubber according to an embodiment. The phase change material changes a state by an environmental change such as temperature. According to this, the specific heat of the intermediate holder 20 is higher than when the intermediate holder is made of rubber alone. Thus, heat can be more efficiently moved to the end holder (the first end holder 10, the second end holder 30) according to an embodiment.

The present disclosure may be a combination of the following configurations according to an embodiment.

(1)

A battery unit including:

a plurality of cylindrical cells arranged in such a way that electrode terminals face in the same direction; and

a cell holder that holds the plurality of cylindrical cells;

wherein the cell holder includes a first end holder, an intermediate holder, and a second end holder which are arranged in order in a length direction of the cylindrical cell,

the intermediate holder includes

an intermediate cylindrical hole that penetrates in the length direction of the cylindrical cell and houses an intermediate portion of the cylindrical cell in the length direction,

a first opening that opens from the intermediate cylindrical hole toward the first end holder,

a first edge that is an edge of the first opening,

a second opening that opens from the intermediate cylindrical hole toward the second end holder, and

a second edge that is an edge of the second opening,

the first end holder includes

a first cylindrical hole that penetrates in the length direction and houses one end of the cylindrical cell in the length direction;

a third opening that opens from the first cylindrical hole toward the intermediate holder, and

a third edge that is an edge of the third opening,

the second end holder includes

a second cylindrical hole that penetrates in the length direction and houses the other end of the cylindrical cell in the length direction,

a fourth opening that opens from the second cylindrical hole toward the intermediate holder, and

a fourth edge that is an edge of the fourth opening,

the first cylindrical hole, the intermediate cylindrical hole, and the second cylindrical hole are arranged in order in the length direction to form a cell housing portion in which one of the cylindrical cells is housed,

the same number of the cell housing portions as the plurality of cylindrical cells are provided,

the first edge and the third edge are abutted against each other to form an annular first mating surface as viewed in the length direction,

the second edge and the fourth edge are abutted against each other to form an annular second mating surface as viewed in the length direction,

at least one of a sectional shape of the first mating surface and a sectional shape of the second mating surface includes an intersection surface intersecting a planar direction orthogonal to the length direction, and

an inner diameter of the intermediate cylindrical hole is smaller than an outer diameter of the cylindrical cell.

(2)

The battery unit according to (1), wherein the intersection surface extends in a circumferential direction.

(3)

The battery unit according to (1), wherein the intersection surface extends in a circumferential direction and is formed in an annular shape.

(4)

The battery unit according to any one of (1) to (3), wherein shapes of the first edge and the second edge are different.

(5)

The battery unit according to any one of (1) to (4), wherein a sectional shape of the intersection surface is a linear slope.

(6)

The battery unit according to (5), wherein a sectional shape of the slope is inclined so as to be located in a first length direction in which the first end holder is disposed as viewed from the intermediate holder as being away from the cylindrical cell.

(7)

The battery unit according to (5), wherein a sectional shape of the slope is inclined so as to be located in a second length direction in which the second end holder is disposed as viewed from the intermediate holder as being away from the cylindrical cell.

(8)

The battery unit according to any one of (1) to (4), wherein a sectional shape of the intersection surface is an arc surface.

(9)

The battery unit according to any one of (1) to (4), wherein a sectional shape of the intersection surface is a V shape obtained by combining two linearly inclined slopes.

(10)

The battery unit according to any one of (1) to (4), wherein the intersection surface extends linearly in the length direction, and

at least one of the sectional shape of the first mating surface and the sectional shape of the second mating surface is a rectangular wave shape.

(11)

The battery unit according to (10), wherein the rectangular wave shape is provided intermittently in the circumferential direction.

(12)

The battery unit according to (10), wherein the rectangular wave shape is provided continuously in the circumferential direction.

(13)

The battery unit according to any one of (1) to (12), wherein the first end holder and the second end holder are formed of thermoplastic resin, and the intermediate holder is formed of an elastic body.

(14)

The battery unit according to (13), wherein the elastic body contains a phase change material.

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

What is claimed is:

1. A battery unit comprising:
a plurality of cylindrical cells arranged such that a plurality of electrode terminals face in a same direction; and
a cell holder that holds the plurality of cylindrical cells;
wherein the cell holder includes a first end holder, an intermediate holder, and a second end holder which are arranged in order in a length direction of the cylindrical cell,
the intermediate holder includes
an intermediate cylindrical hole that penetrates in the length direction of the cylindrical cell and houses an intermediate portion of the cylindrical cell in the length direction,
a first opening that opens from the intermediate cylindrical hole toward the first end holder,
a first edge that is an edge of the first opening,
a second opening that opens from the intermediate cylindrical hole toward the second end holder, and
a second edge that is an edge of the second opening,
the first end holder includes
a first cylindrical hole that penetrates in the length direction and houses one end of the cylindrical cell in the length direction;
a third opening that opens from the first cylindrical hole toward the intermediate holder, and
a third edge that is an edge of the third opening,
the second end holder includes
a second cylindrical hole that penetrates in the length direction and houses the other end of the cylindrical cell in the length direction,
a fourth opening that opens from the second cylindrical hole toward the intermediate holder, and
a fourth edge that is an edge of the fourth opening,
the first cylindrical hole, the intermediate cylindrical hole, and the second cylindrical hole are arranged in order in the length direction to form a cell housing portion in which one of the cylindrical cells is housed,
a same number of the cell housing portions as the plurality of cylindrical cells are provided,
the first edge and the third edge are abutted against each other to form an annular first mating surface as viewed in the length direction,
the second edge and the fourth edge are abutted against each other to form an annular second mating surface as viewed in the length direction,
at least one of a sectional shape of the first mating surface and a sectional shape of the second mating surface includes an intersection surface intersecting a planar direction orthogonal to the length direction, and
an inner diameter of the intermediate cylindrical hole is smaller than an outer diameter of the cylindrical cell.

2. The battery unit according to claim 1, wherein the intersection surface extends in a circumferential direction.

3. The battery unit according to claim 1, wherein the intersection surface extends in a circumferential direction and is provided in an annular shape.

4. The battery unit according to claim 1, wherein of the first edge and the second edge are different in shape.

5. The battery unit according to claim 1, wherein a sectional shape of the intersection surface is a linear slope.

6. The battery unit according to claim 5, wherein a sectional shape of the slope is inclined so as to be located in a first length direction in which the first end holder is disposed as viewed from the intermediate holder as being away from the cylindrical cell.

7. The battery unit according to claim 5, wherein a sectional shape of the slope is inclined so as to be located in a second length direction in which the second end holder is disposed as viewed from the intermediate holder as being away from the cylindrical cell.

8. The battery unit according to claim 1, wherein a sectional shape of the intersection surface is an arc surface.

9. The battery unit according to claim 1, wherein a sectional shape of the intersection surface is a V shape obtained by combining two linearly inclined slopes.

10. The battery unit according to claim 1, wherein the intersection surface extends linearly in the length direction, and
at least one of the sectional shape of the first mating surface and the sectional shape of the second mating surface is a rectangular wave shape.

11. The battery unit according to claim 10, wherein the rectangular wave shape is provided intermittently in the circumferential direction.

12. The battery unit according to claim 10, wherein the rectangular wave shape is provided continuously in the circumferential direction.

13. The battery unit according to claim 1, wherein the first end holder and the second end holder are formed of thermoplastic resin, and
the intermediate holder is formed of an elastic body.

14. The battery unit according to claim 13, wherein the elastic body contains a phase change material.
